(19) United States
(12) Patent Application Publication
(10) Pub. No.: US 2023/0186192 A1
(43) Pub. Date: Jun. 15, 2023

(54) INTELLIGENT TASK ASSIGNMENT AND PERFORMANCE

(71) Applicant: Citrix Systems, Inc., Fort Lauderdale, FL (US)

(72) Inventor: Chunrong Xia, Nanjing (CN)

(21) Appl. No.: 17/648,201

(22) Filed: Jan. 18, 2022

Related U.S. Application Data
(63) Continuation of application No. PCT/CN2021/136954, filed on Dec. 10, 2021.

(51) Int. Cl. G06Q 10/06; G06Q 10/10

(52) U.S. Cl. CPC G06Q 10/063112; G06Q 10/103

(57) ABSTRACT

In one aspect, an example methodology implementing the disclosed techniques can include, by a computing device, receiving a summary of a task and determining, using one or more machine learning models, information relevant to the task based on the summary of the task. The method can also include, by the computing device, responsive to the determination of information relevant to the task, outputting the information relevant to the task for use in assigning the task.

### CROSS REFERENCE TO RELATED APPLICATIONS

This application is a continuation of and claims the benefit of PCT Patent Application No. PCT/CN2021/136954 filed on Dec. 10, 2021 in the English language in the State Intellectual Property Office and designating the United States, the contents of which are hereby incorporated herein by reference in its entirety.

### BACKGROUND

Organizations work on many projects at the same time. Many of these projects may be large projects that involve a number of smaller tasks which need to be assigned and performed for the successful completion of a project. For example, within a company, a project manager may be responsible for assigning the tasks to various employees or other persons associated with the company (“associates”). It is not uncommon for the project manager to use a project management tool to monitor the progress of the individual tasks. While traditional project management tools provide numerous features to manage a project to timely completion, they do not help the project manager with the initial assignment of the tasks. Rather, the project manager typically assigns the tasks based on his or her knowledge of the skill sets of the employees and associates.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

It is appreciated herein that it can be very difficult and/or time consuming to properly assign a task to a resource. For example, an organization such as a company may have many employees, each employee having a skill set. Also, within the company, there may be a large number of projects and corresponding tasks that are being performed by the employees at any given time. For a project manager to properly assign a task, it may be necessary for the project manager to have knowledge of the company’s projects and tasks and the skill sets of the company’s employees. This is especially true where the task is to be assigned to a different project team (e.g., a project that may not be managed by the project manager). For example, the project manager may need this information to determine who to assign the task to and whether there are any similar tasks. Obtaining the knowledge necessary to properly assign a task may be inefficient in terms of time and user productivity.

At the other end of the task delegation, an employee to whom the task is assigned may be unfamiliar with the assigned task. For example, the employee who is assigned the task may not clearly understand the assigned task and/or how to perform the assigned task. Also, the employee may not know whether there are similar tasks and how those similar tasks were performed or whether there are any mentors (e.g., domain experts) who can guide the employee in successfully completing the assigned task. The lack of such information may cause the employee to be less productive in that the employee would need to spend more time performing the task. Embodiments of the present disclosure provide solutions to these and other technical problems described herein.

The present disclosure relates to concepts and techniques for collecting information regarding existing tasks and, from the collected information, presenting information that is relevant to a new task to a user as the user is creating the new task, thereby allowing the user to properly assign the new task. The information regarding the existing tasks can be collected from various data sources. The collected information can then be used to generate dataset(s) that can be used to train one or more learning algorithms using machine learning techniques (e.g., machine learning model(s)) to identify information that is relevant to a task (e.g., a new task). The information that is relevant to a new task can be presented to a user, and the user can use the presented information to properly assign the new task. The user is also able to determine, from the presented information that is relevant to a new task, whether the new task is a duplicate of or similar to an existing task. In some cases, the information that is relevant to a new task can be presented to a user who is assigned the new task (i.e., an assignee), and the user can use the presented information in performing the assigned task. The concepts and techniques described herein can be used to improve the efficiency and utility of existing computer systems and applications, such as existing project management applications (e.g., CITRIX WRIKE).

In accordance with one example embodiment provided to illustrate the broader concepts, systems, and techniques described herein, a method includes, by a computing device, receiving a summary of a task and determining, using one or more machine learning models, information relevant to the task based on the summary of the task. The method also includes, by the computing device, responsive to the determination of information relevant to the task, outputting the information relevant to the task for use in assigning the task.

In some embodiments, the method also includes, by the computing device, receiving an assignment of another task to an assignee. The method further includes, by the computing device, responsive to a determination that additional information relevant to the assigned another task is not provided with the assignment of the another task, determining one or more items of information relevant to the another task based on the assignment of the another task and presenting the information relevant to the another task to the assignee.

According to another illustrative embodiment provided to illustrate the broader concepts described herein, a system includes a processor and a non-volatile memory storing computer program code. The computer program code, when executed on the processor, causes the processor to execute a process operable to receive a summary of a task and determine, using one or more machine learning models, information relevant to the task based on the summary of the task. The process is also operable to, responsive to the determination of information relevant to the task, output the information relevant to the task for use in assigning the task.

In some embodiments, the process is also operable to receive an assignment of another task to an assignee and, responsive to a determination that additional information relevant to the assigned another task is not provided with the assignment of the another task, determine one or more items of information relevant to the another task based on the assignment of the another task and present the information relevant to the another task to the assignee.

According to another illustrative embodiment provided to illustrate the broader concepts described herein, a method includes, receiving, by a computing device, an assignment of a task to an assignee. The method also includes, responsive to a determination that additional information relevant to the assigned task is not provided with the assignment of the task, by the computing device, determining one or more items of information relevant to the task based on the assignment of the task and presenting the information relevant to the task to the assignee.

According to another illustrative embodiment provided to illustrate the broader concepts described herein, a system includes a processor and a non-volatile memory storing computer program code. The computer program code, when executed on the processor, causes the processor to execute a process operable to receive an assignment of a task to an assignee. The process is also operable to, responsive to a determination that additional information relevant to the assigned task is not provided with the assignment of the task, determine one or more items of information relevant to the task based on the assignment of the task and present the information relevant to the task to the assignee.

In some embodiments, the one or more items of information relevant to the task are determined using one or more machine learning models.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a block diagram of an illustrative system for intelligent task assignment and performance, in accordance with an embodiment of the present disclosure.

FIG. 6 shows an example of a user interface (UI) that may be used to present information relevant to a new task to a user who is creating the new task, in accordance with an embodiment of the present disclosure.

FIG. 7 shows an example of a user interface (UI) that may be used to present information relevant to an assigned task to a user who is assigned the task, in accordance with an embodiment of the present disclosure.

FIG. 8 is a flow diagram of an illustrative process for presenting information relevant to a new task to a user who is creating the new task, in accordance with an embodiment of the present disclosure.

FIG. 9 is a flow diagram of an illustrative process for presenting information relevant to an assigned task to a user who is assigned the task, in accordance with an embodiment of the present disclosure.

### DETAILED DESCRIPTION

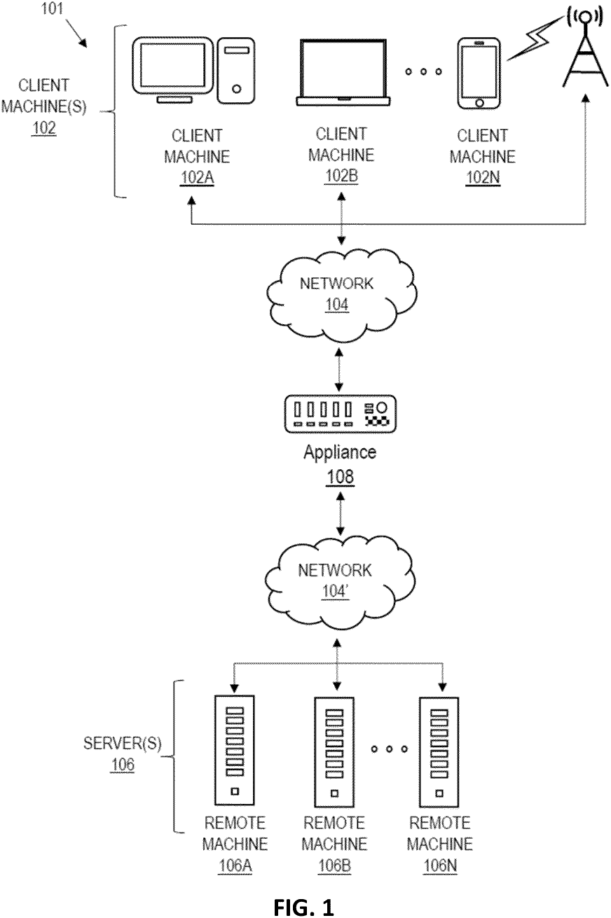

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

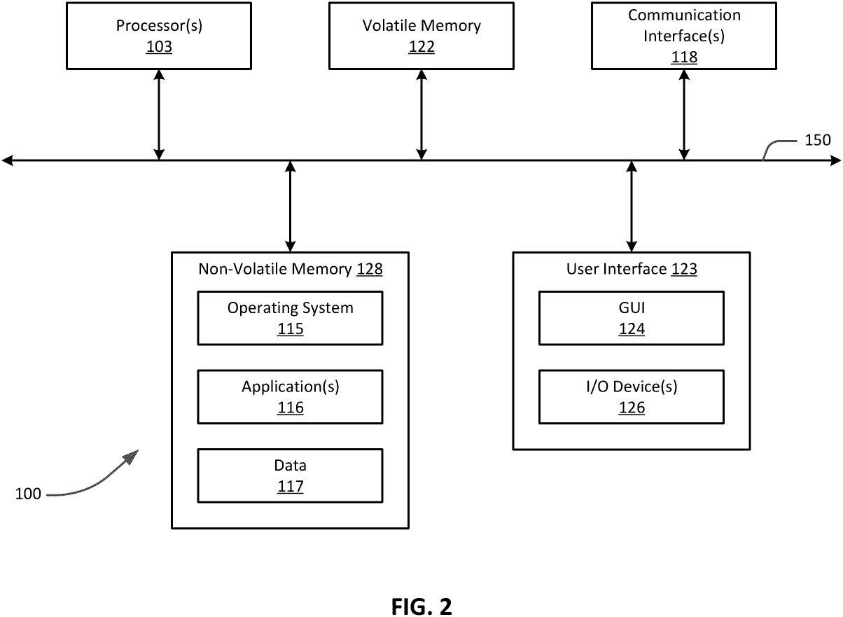

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

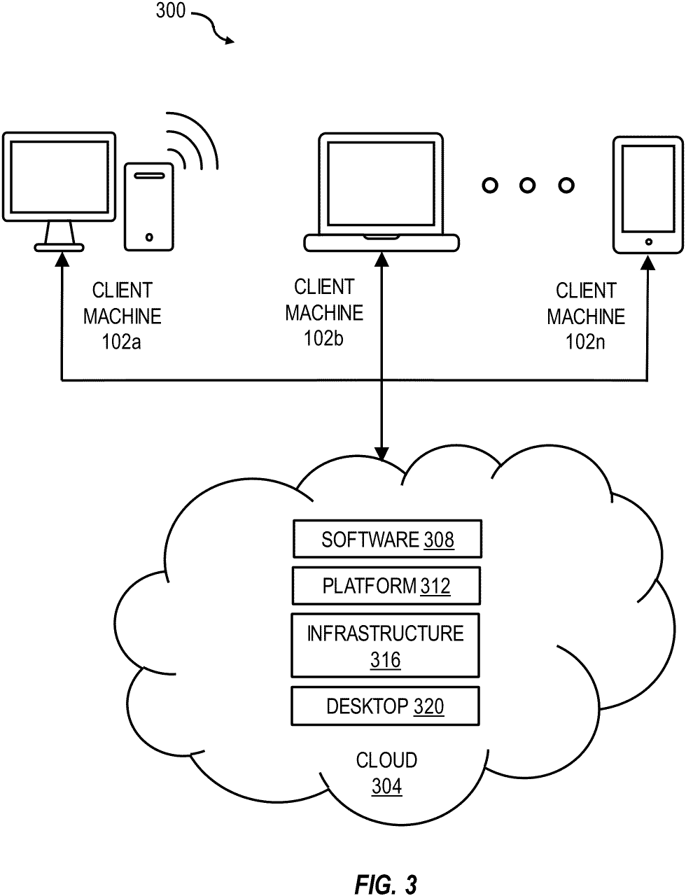

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

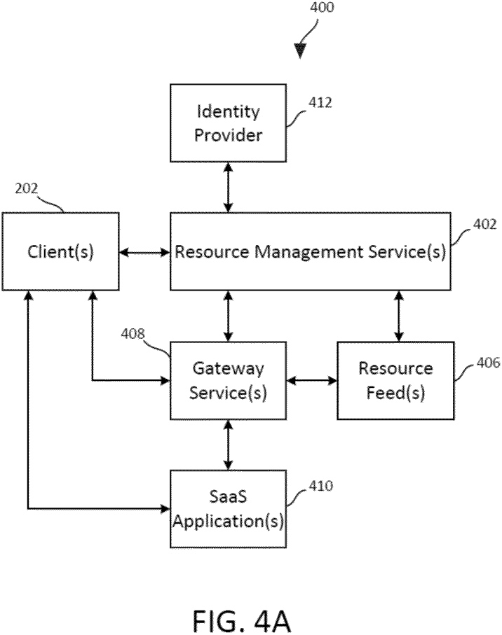

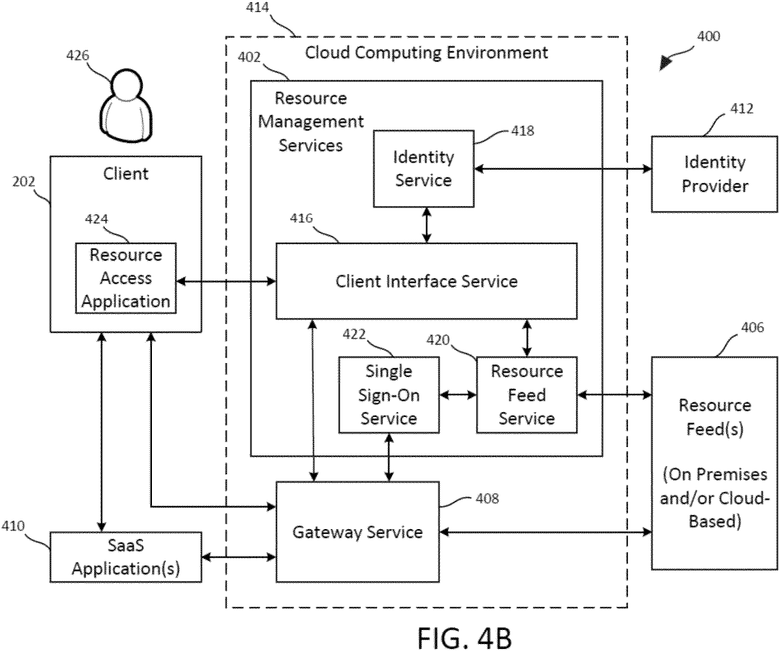

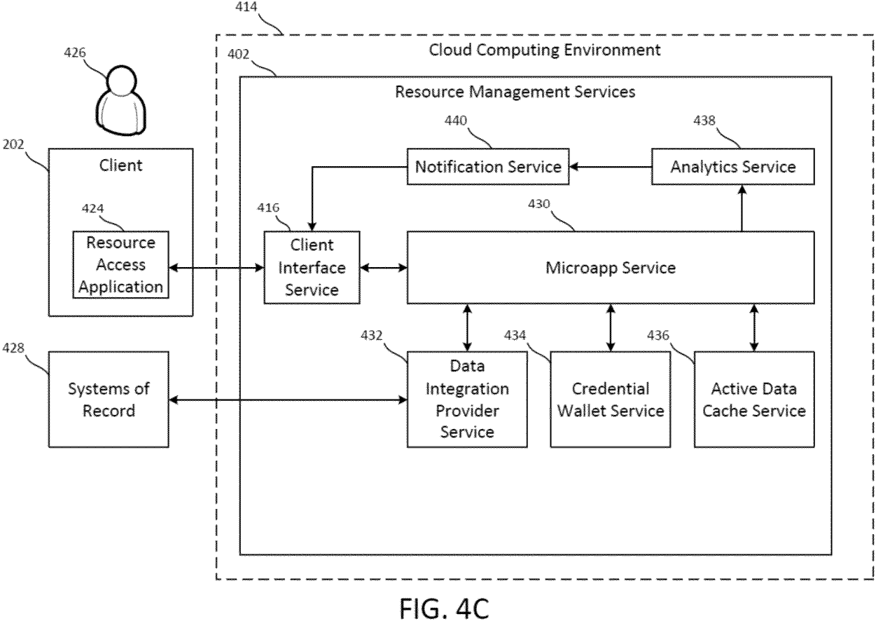

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user’s SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user’s authentication credentials (e.g., username and password). Upon receiving the user’s authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user’s identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user’s authentication credentials. Upon determining the user’s identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user’s identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user’s feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user’s attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user’s actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith’s phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they’re looking for.

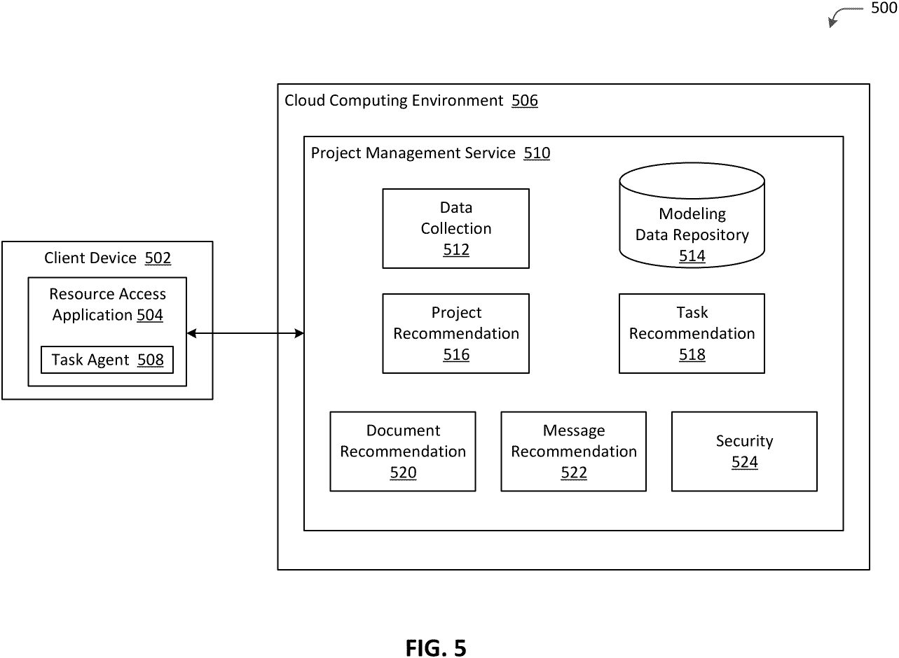

FIG. 5 is a block diagram of an illustrative system 500 for intelligent task assignment and performance, in accordance with an embodiment of the present disclosure. System 500 includes a resource access application 504 installed on a client device 502 and configured to communicate with a cloud computing environment 506. Client device 502, resource access application 504, and cloud computing environment 506 of FIG. 5 can be the same as or similar to client 202, resource access application 424, and cloud computing environment 414, respectively, of FIGS. 4A-4C.

As shown in FIG. 5, a task agent 508 can be provided as a sub-module or other component of resource access application 504. A project management service 510 can be provided as a service (e.g., a microservice) within cloud computing environment 506. Task agent 508 and project management service 510 can interoperate to present information that is relevant to a task to a user of resource access application 504. In some embodiments, this information may be presented when the task is being created (i.e., generated) to assist the user in properly assigning the task, for example. In some embodiments, this information may be presented to the user who is assigned the task to assist the user in performing the assigned task, for example.

To promote clarity in the drawings, FIG. 5 shows a single resource access application 504 communicably coupled to project management service 510. However, embodiments of project management service 510 can be used to service many resource access applications 504 used by many different users associated with one or more organizations. Task agent 508 and/or project management service 510 may be implemented as computer instructions executable to perform the corresponding functions disclosed herein. Task agent 508 and project management service 510 can be logically and/or physically organized into one or more components. In the example of FIG. 5, project management service 510 includes a data collection module 512, a modeling data repository 514, a project recommendation module 516, a task recommendation module 518, a document recommendation module 520, a message recommendation module 522, and a security module 524. Also, in this example, task agent 508 can include UI controls (not shown) to enable a user to access project management service 510. As task agent 508 is a component of resource access application 504, the UI controls for accessing project management service 510 may be accessed within resource access application 502.

The client-side task agent 508 can communicate with the cloud-side project management service 510. For example, task agent 508 can send requests (e.g., HTTP requests) to project management service 510 wherein the requests are received and processed by project management service 510 or one or more components of project management service 510. Likewise, project management service 510 can send responses (e.g., HTTP responses) to task agent 508 wherein the responses are received and processed by task agent 508.

Referring to project management service 510, data collection module 512 is operable to collect or otherwise retrieve information regarding existing tasks from the organization’s project management application (e.g., project management service 510) along with other information regarding the tasks from the organization’s collaboration applications and data repositories. Such information regarding the tasks is sometimes referred to herein more simply as “task-related information.” The collected task-related information is regarding existing tasks (e.g., finished and unfinished tasks) that have been created using the project management application for the organization. The project management application (e.g., project management service 510) may be, for example, WRIKE, JIRA, BASECAMP, TRELLO, or other suitable product/project management application. The collaboration applications can include, for example, EXCHANGE, SLACK, CONFLUENCE, TRELLO, TEAMS, ZOOM, or other suitable collaboration/messaging application. The data repositories can include, for example, DROPBOX, MICROSOFT ONEDRIVE, SHAREFILE, cloud-based storage service, or other suitable file system that hosts files, documents, and other materials.

Data collection module 512 may utilize APIs provided by the various data sources to collect information therefrom. For example, data collection module 512 may use a REST-based API provided by the project management application to collect task-related information therefrom. As another example, data collection module 512 may use MICROSOFT GRAPH APIs to collect information from EXCHANGE and/or TEAMS. As yet another example, data collection module 512 may use a Web API provided by SLACK to collect information from SLACK, and a ZOOM API provided by ZOOM to collect information from ZOOM. As another example, data collection module 512 may use a file system interface to collect information regarding files from a file system. As yet another example, data collection module 512 may use an API to collect information regarding documents from a cloud-based storage service.

The particular data sources (i.e., the project management application, the collaboration applications, and the data repositories) from which data collection module 512 collects the task-related information can vary between different organizations. In some embodiments, data collection module 512 can obtain a list of data sources used by a particular organization. For example, an organization serviced by project management service 510 may use Wrike as a project management service 510 and EXCHANGE, SLACK, TRELLO, CONFLUENCE, and DROPBOX as the collaboration applications and data repository, whereas another organization may use JIRA, EXCHANGE, SLACK, TEAMS, and MICROSOFT ONEDRIVE. Data collection module 512 can determine which data sources to collect the task-related information from based on configuration information maintained for an organization. In some embodiments, data collection module 512 may obtain a list of subscribed resources (e.g., applications and services) for a particular organization via resource feed service 420 of FIG. 4B. Data collection module 512 may also obtain authentication credentials (e.g., administrator password(s), access token(s), etc.) which may be needed to access one or more of the data sources for collecting task-related information.

Data collection module 512 can collect information regarding the existing tasks from project management service 510. The collected information can include, for a particular task, information such as an identifier (e.g., task id), a project/space to which the task belongs (e.g., project/space id), the user who created the task, an assignee to whom the task is assigned, a status of the task, a summary of the task, and a description of the task. These examples of information regarding an existing task are merely illustrative and may vary depending on the capabilities of project management service 510. In some embodiments, data collection module 512 can collect information about the existing tasks from project management service 510 on a continuous or periodic basis.

Data collection module 512 can use the information regarding the existing tasks collected from project management service 510 to generate a modeling dataset for training a learning algorithm (e.g., a convolutional neural network (CNN) or other deep learning algorithm) using machine learning techniques to predict a project/space for a task (e.g., a new task). For example, as will be further described below, the modeling dataset may be used to train a machine learning algorithm for project recommendation module 516.

To generate a modeling dataset for training a machine learning algorithm for project recommendation module 516, data collection module 512 can perform preprocessing of the collected text data (e.g., information regarding the existing tasks). For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stopwords removal, stemming, and/or lemmatization. The data preprocessing may also include placing the data into a tabular format. In the table, the structured columns represent the features (also called variables) and each row represents an observation or instance (e.g., an existing task). Thus, each column in the table shows a different feature of the instance. The preliminary operations may also include feature selection and/or data engineering to determine the relevant features. The relevant features are the features that are more correlated with the thing being predicted by the trained model (e.g., a project/space within which a task is to be assigned). A variety of feature engineering techniques, such as exploratory data analysis (EDA) and/or bivariate data analysis with multivariate-variate plots and/or correlation heatmaps and diagrams, among others, may be used to determine the relevant features. Such feature engineering may be performed to reduce the dimension and complexity of the trained model, hence improving its accuracy and performance. The data preprocessing may also include placing the data (information) in the table into a format that is suitable for training a model. For example, since machine learning deals with numerical values, textual categorical values (i.e., free text) in the columns can be converted (i.e., encoded) into numerical values using techniques such as label encoding or one-hot encoding. Data collection module 512 can store the generated modeling dataset for project recommendation module 516 in modeling data repository 514.

In some embodiments, data collection module 512 can also use the information about the existing tasks collected from project management service 510 to generate a modeling dataset for training a learning algorithm (e.g., k-nearest neighbor (k-NN) or other classification algorithm) using machine learning techniques to identify, using a distance similarity measure algorithm (e.g., cosine similarity or Euclidean distance) for example, one or more existing tasks that are similar to a task (e.g., a new task). For example, as will be further described below, the modeling dataset may be used to train a machine learning algorithm for task recommendation module 518.

To generate a modeling dataset for training the classification algorithm (e.g., k-NN algorithm) for task recommendation module 518, data collection module 512 can perform preprocessing of the collected text data (e.g., information regarding existing tasks). For example, the data preprocessing may include tokenization, noise removal, stopwords removal, stemming, and/or lemmatization, as described previously. The data preprocessing may also include placing the data into a tabular format. In the table, the structured columns represent the features and each row represents an observation or instance (e.g., an existing task). Note that k-NN is a non-parametric and instance-based learning algorithm, meaning that the k-NN algorithm does not make any assumptions on the underlying data and doesn’t explicitly learn a model. Instead, the k-NN algorithm memorizes the training instances which are subsequently used as knowledge for the prediction phase. That is, the training phase of the k-NN algorithm comprises only of storing the set of features (or “feature vectors”) and the target variables (e.g., task ids) of the training samples. However, if the training sample (i.e., modeling dataset) has too many features, then there is a high risk of overfitting the k-NN model, leading to an inaccurate model. Hence, the data preprocessing may also include feature selection and dimensionality reduction using techniques such as principal component analysis (PCA), linear discriminant analysis (LDA), or canonical correlation analysis (CCA), to determine the relevant features, thus reducing the number of features or dimensions. The data preprocessing may also include placing the data in the table into a format that is suitable for applying by the model (e.g., numerical values) using techniques such as label encoding or one-hot encoding. Data collection module 512 can store the generated modeling dataset for task recommendation module 518 in modeling data repository 514.

In some embodiments, data collection module 512 can collect information regarding documents (e.g., files) related to existing tasks from the organization’s various data sources. An organization may provide its users many different types of data sources for creating and maintaining documents regarding existing tasks. For example, users may create documents regarding tasks using applications such as SLACK, TRELLO, CONFLUENCE, etc. The created documents may be stored within the application and/or within a separate data repository, such as DROPBOX or MICROSOFT ONEDRIVE. In general, the collected information can include, for a particular document, information such as a document name or identifier (e.g., doc id), file size, the content or a summary of the content, date of document creation, the names of the author and most recent modifier, and other summary information about the document. These examples of information regarding a document are merely illustrative and may vary depending on the capabilities of the application used to create the document. In some embodiments, data collection module 512 can collect such information regarding the documents from the various data sources on a continuous or periodic basis.

Data collection module 512 can use the information regarding the documents collected from the organization’s various data sources to generate a modeling dataset for training a learning algorithm (e.g., k-NN or other classification algorithm) using machine learning techniques to identify, using a distance similarity measure algorithm (e.g., cosine similarity or Euclidean distance) for example, one or more documents that are relevant to a task (e.g., a new task). For example, as will be further described below, the modeling dataset may be used to train a machine learning algorithm for document recommendation module 520.

To generate a modeling dataset for training the classification algorithm (e.g., k-NN algorithm) for document recommendation module 520, data collection module 512 can perform preprocessing of the collected text data (e.g., information regarding documents related to existing tasks). For example, the data preprocessing may include tokenization, noise removal, stopwords removal, stemming, and/or lemmatization, as described previously. The data preprocessing may also include placing the data into a tabular format, where the structured columns in the table represent the features and each row represents an observation or instance (e.g., a document). As noted above, k-NN is a non-parametric and instance-based learning algorithm and the training phase of the k-NN algorithm comprises only of storing the set of features (or “feature vectors”) and the target variables (e.g., document ids) of the training samples. The data preprocessing may also include feature selection and dimensionality reduction using techniques such as PCA, LDA, or CCA, to determine the relevant features, thus reducing the number of features or dimensions. The data preprocessing may also include placing the data in the table into a format that is suitable for applying by the model (e.g., numerical values) using techniques such as label encoding or one-hot encoding. Data collection module 512 can store the generated modeling dataset for document recommendation module 520 in modeling data repository 514.

In some embodiments, data collection module 512 can collect information regarding messages related to existing tasks from the organization’s various data sources. An organization may provide its users many different types of data sources for sending and receiving messages regarding existing tasks. For example, users may send and received messages using applications such as EXCHANGE, SLACK, TRELLO, CONFLUENCE, etc. The messages may be stored within the application and/or within a separate data repository, such as DROPBOX or MICROSOFT ONEDRIVE. In general, the collected information can include, for a particular message, information such as a message identifier (e.g., message id), a subject of the message, the content or a summary of the content included in the message, a timestamp which indicates when the message was sent/received, sender of the message, recipient(s) of the message, and other summary information about the message. These examples of information regarding a message are merely illustrative and may vary depending on the capabilities of the application used to send/receive the message. In some embodiments, data collection module 512 can collect such information regarding the messages from the various data sources on a continuous or periodic basis.

Data collection module 512 can use the information regarding the messages collected from the organization’s various data sources to generate a modeling dataset for training a learning algorithm (e.g., k-NN or other classification algorithm) using machine learning techniques to identify, using a distance similarity measure algorithm (e.g., cosine similarity or Euclidean distance) for example, one or more messages that are relevant to a task (e.g., a new task). For example, as will be further described below, the modeling dataset may be used to train a machine learning algorithm for message recommendation module 522.

To generate a modeling dataset for training the classification algorithm (e.g., k-NN algorithm) for message recommendation module 522, data collection module 512 can perform preprocessing of the collected text data (e.g., information regarding messages related to existing tasks). For example, the data preprocessing may include tokenization, noise removal, stopwords removal, stemming, and/or lemmatization, as described previously. The data preprocessing may also include placing the data into a tabular format, where the structured columns in the table represent the features and each row represents an observation or instance (e.g., a message). As noted above, k-NN is a non-parametric and instance-based learning algorithm and the training phase of the k-NN algorithm comprises only of storing the set of features (or “feature vectors”) and the target variables (e.g., message ids) of the training samples. The data preprocessing may also include feature selection and dimensionality reduction using techniques such as PCA, LDA, or CCA, to determine the relevant features, thus reducing the number of features or dimensions. The data preprocessing may also include placing the data in the table into a format that is suitable for applying by the model (e.g., numerical values) using techniques such as label encoding or one-hot encoding. Data collection module 512 can store the generated modeling dataset for message recommendation module 522 in modeling data repository 514.

Project recommendation module 516 can, in response to receiving a summary of a task that is to be assigned (e.g., a new task), identify a project/space that is relevant to the task based on the provided summary of the task. The identified project/space, which is a project/space within the organization’s project management application (e.g., project management service 510), can then be recommended to a user of the organization’s project management application. For example, the user can consider assigning or not assigning the task to or within the recommended project/space. To this end, in some embodiments, project recommendation module 516 can implement a learning algorithm such as a CNN or other deep learning algorithm. In such embodiments, the learning algorithm can be trained using machine learning techniques with a modeling dataset (e.g., the modeling dataset generated for project recommendation module 516, as described above) to predict (i.e., identify) a project/space within the organization’s project management application that is most relevant to a given (input) task. For example, since the modeling dataset is comprised of “labeled” training samples, supervised machine learning may be used to train the learning algorithm to predict outcomes (e.g., a project/space) correctly. To train the learning algorithm, the modeling dataset may be partitioned into a training dataset and a testing dataset, and initial weights may be randomly assigned to the different features. As the learning algorithm iterates through the training dataset, the learning algorithm adjusts the weights according to the characteristics of the learning algorithm. Periodically, the performance of the learning algorithm may be evaluated by using the learning algorithm in its current state to process the testing dataset, and calculating a value of a loss function, such as, for example, the overall root mean squared error between the phenomenon of interest (the target variable) in the modeling data (e.g., project/space id) and the output of the learning algorithm. The value of the loss function indicates how well the learning algorithm is trained. When the performance of the learning algorithm on the testing dataset stops improving (e.g., the value of the loss function is reduced to a very small number (ideally close to zero)), the learning algorithm is considered sufficiently trained and the learning algorithm makes no further adjustments to the weights. The result of the training of the learning algorithm is a machine learning model that is sufficiently trained, and which can be used to make predictions.

Task recommendation module 518 can, in response to receiving a summary of a task (e.g., a new task to be assigned or a newly assigned task), identify one or more existing tasks that are similar to the task based on the provided summary of the task. The identified tasks can then be recommended to a user of the organization’s project management application. For example, information regarding the identified tasks can be presented to a user who is creating the task for consideration in including as information relevant to the task when assigning the task. As another example, information regarding the identified tasks can be presented to a user who is assigned the task for use as references in performing the assigned task. To this end, in some embodiments, task recommendation module 518 can implement a learning algorithm such as a k-NN or other classification algorithm. As noted above, k-NN is a non-parametric and instance-based learning algorithm, meaning that the k-NN algorithm does not make any assumptions on the underlying data and doesn’t explicitly learn a model. To identify the existing tasks that are relevant to a task, the k-NN algorithm relies on feature similarity between the features of the task and the features of the existing tasks in a modeling dataset (e.g., the modeling dataset generated for task recommendation module 518, as described above). For example, provided a task (e.g., a feature vector representing the task) as an input, the k-NN algorithm can use a distance similarity measure algorithm (e.g., cosine similarity or Euclidean distance) to calculate a “distance” between the input task and the individual existing tasks in the modeling dataset. Based on the calculated distances and a value specified for k, the k-NN algorithm can identify the existing tasks (e.g., k existing tasks) that are nearest (e.g., most similar) to the input task.

Document recommendation module 520 can, in response to receiving a summary of a task (e.g., a new task to be assigned or a newly assigned task), identify one or more documents that are relevant to the task based on the provided summary of the task. The identified documents can then be recommended to a user of the organization’s project management application. For example, information regarding the identified documents can be presented to a user who is creating the task for consideration in including as information relevant to the task when assigning the task. As another example, information regarding the identified documents can be presented to a user who is assigned the task for use as references in performing the assigned task. To this end, in some embodiments, document recommendation module 520 can implement a learning algorithm such as a k-NN or other classification algorithm. To identify the documents that are relevant to a task, the k-NN algorithm relies on feature similarity between the features of the task and the features of the documents in a modeling dataset (e.g., the modeling dataset generated for document recommendation module 520, as described above). For example, provided a task (e.g., a feature vector representing the task) as an input, the k-NN algorithm can use a distance similarity measure algorithm (e.g., cosine similarity or Euclidean distance) to calculate a “distance” between the input task and the individual documents in the modeling dataset. Based on the calculated distances and a value specified for k, the k-NN algorithm can identify the documents (e.g., k documents) that are nearest (e.g., most relevant) to the input task.

Message recommendation module 522 can, in response to receiving a summary of a task (e.g., a new task to be assigned or a newly assigned task), identify one or more messages that are relevant to the task based on the provided summary of the task. The identified messages can then be recommended to a user of the organization’s project management application. For example, information regarding the identified messages can be presented to a user who is creating the task for consideration in including as information relevant to the task when assigning the task. As another example, information regarding the identified messages can be presented to a user who is assigned the task for use as references in performing the assigned task. To this end, in some embodiments, message recommendation module 522 can implement a learning algorithm such as a k-NN or other classification algorithm. To identify the messages that are relevant to a task, the k-NN algorithm relies on feature similarity between the features of the task and the features of the messages in a modeling dataset (e.g., the modeling dataset generated for message recommendation module 522, as described above). For example, provided a task (e.g., a feature vector representing the task) as an input, the k-NN algorithm can use a distance similarity measure algorithm (e.g., cosine similarity or Euclidean distance) to calculate a “distance” between the input task and the individual messages in the modeling dataset. Based on the calculated distances and a value specified for k, the k-NN algorithm can identify the messages (e.g., k messages) that are nearest (e.g., most relevant) to the input task.

Security module 524 can incorporate security policies to enforce one or more restrictions on the information that is presented to users. For example, the organization can define, for each user associated with the organization, a security policy that defines a type of access that particular user is permitted with respect to the organization’s applications and content. In some embodiments, prior to the information regarding materials that are relevant to a task (e.g., information regarding an existing project, existing tasks, documents, and/or messages) being sent to task agent 508 for presenting to a user, security module 524 can check to determine whether, based on a security policy defined for the user, the user is permitted to access the materials referenced by the information. If security module 524 determines that the user is not permitted to access some or all the materials, security module 524 can remove from the information that is to be sent to the user the information regarding the materials the user is not permitted to access. For example, suppose information regarding a relevant Task A, Task B, Document C, Document D, and Message E is to be sent to a user. Also suppose that security module 524 determines that, based on a security policy defined for the user, the user is not permitted to access Task B and Document D. In this case, security module 524 can remove the information regarding Task B and Document D from the information to be sent to the user such that information regarding relevant Task A, Document C, and Message E is sent to the user. In other words, information regarding materials (e.g., Task B and Document D in this example) the user is not permitted to access is not sent to the user and only information regarding materials (e.g., Task A, Document C, and Message E in this example) the user is permitted to access is sent to the user.

With continued reference to FIG. 5, task agent 508 can include various UI controls to enable a user to receive and/or access information relevant to a task. For example, the UI controls can include a control that a user who is creating a task (e.g., a new task) can activate (e.g., click, tap, or select) to obtain information relevant to the task. As another example, the UI controls can include a control that a user who is assigned a task (e.g., a new task) can activate (e.g., click, tap, or select) to obtain information relevant to the assigned task. In either case, in response to the user’s input, task agent 508 can send a request for information that is relevant to the task to project management service 510. The request sent to project management service 510 can include information regarding the task (e.g., a summary of the task). In response to the request, project management service 510 can use modules 516, 518, 520, 522 to identify materials (e.g., an existing project, existing tasks, documents, and/or messages) that are relevant to the task. Project management service 510 can then send information regarding the identified materials that are relevant to the task to task agent 508. In some embodiments, security module 524 of project management service 510 can be used to determine whether the user is permitted to access the identified materials prior to project management service 510 sending the information to task agent 508, as previously described herein.

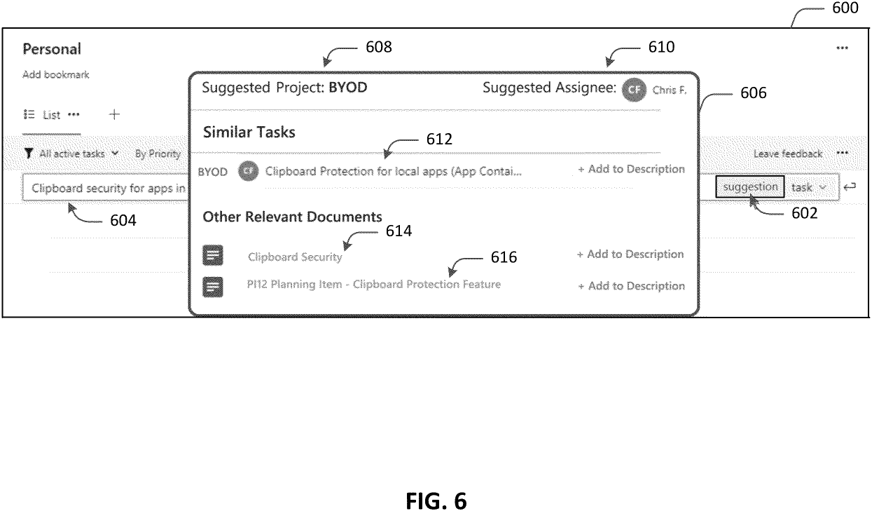

FIG. 6 shows an example of a user interface (UI) that may be used to present information relevant to a new task to a user who is creating the new task, in accordance with an embodiment of the present disclosure. An illustrative UI 600 may be implemented within a resource access application, such as resource access application 504 of FIG. 5. UI 600 may operate to enable a user to create a new task within the organization’s project management application (e.g., project management service 510 of FIG. 5). As shown in FIG. 6, UI 600 can include a “suggestion” button 602 which can be activated (e.g., clicked, tapped, or selected) to obtain information relevant to a new task that is being created using UI 600.

In the example of FIG. 6, UI 600 may be presented to a user to allow the user to create a new task. For example, as indicated by reference numeral 604, the user may be creating a new task titled “Clipboard security for apps in virtual desktop” (note that a portion of the title, “virtual desktop”, is hidden behind a popup window 606). When creating the new task, the user may activate “suggestion” button 602 to obtain information that is relevant to the new task that the user is creating. For example, the user may be unsure of the project/space, if any, the new task should be assigned to. As another example, the user may be unsure of which user should be assigned the new task. As another example, the user may want to see whether there are any existing tasks that are similar to the new task. As still another example, the user may want to see whether there are any materials (e.g., documents and messages) that are relevant to the new task.

In response to the user activating “suggestion” button 602, UI 600 can cause a request to be sent to project management service 510 to obtain information relevant to the new task. The request may include the user’s identifier (e.g., a unique user identifier of the user) and a summary of the new task (e.g., a task title, a brief description of the new task, etc.) which project management service 510 can use to determine whether there are materials that are relevant to the new task. Project management service 510 can identify materials that are relevant to the new task using project recommendation module 516 (e.g., to identify a project/space that is relevant to the new task), task recommendation module 518 (e.g., to identify existing tasks that are similar to the new task), document recommendation module 520 (e.g., to identify existing documents that are relevant to the new task), and message recommendation module 522 (e.g., to identify existing messages that are relevant to the new task). In some embodiments, project management service 510 can determine whether the user is permitted to access the identified materials (e.g., the identified project/space, existing tasks, existing documents, and existing messages) using security module 524. Project management service 510 can send information regarding the materials that are relevant to the new task and which the user is permitted to access to task agent 508.

In response to the information regarding the materials that are relevant to the new task being received, UI 600 can display the received information in popup window 606. As shown in popup window 606, a project titled “BYOD” is suggested as a project/space for the new task (see reference numeral 608) and a user named “Chris F.” is suggested as an assignee for the new task (see reference numeral 610). As also shown in popup window 606, an existing task titled “Clipboard Protection for local apps (App Conti...” in project “BYOD” and assigned to the user named “Chris F.” is identified as an existing task that is similar to the new task (see reference numeral 612). As also shown in popup window 606, two (2) TRELLO documents are identified as documents that are relevant to the new task (see reference numerals 614, 616). The user can then consider the information relevant the new task displayed in popup window 606 in creating the new task titled “Clipboard security for apps in virtual desktop.” For example, the user can consider the suggestion to create the new task in the project titled “BYOD.” The user can also consider assigning the new task to the user named “Chris F.” The user can also consider including the information regarding one or more of the identified similar task and the two (2) relevant TRELLO documents in the description of the new task as reference information. As shown in popup window 606, the user can include the information regarding any one or more of the listed entries (i.e., the identified similar task and the two (2) relevant TRELLO documents) by activating a descriptive link titled “+ Add to Description” appearing next to each listed entry.

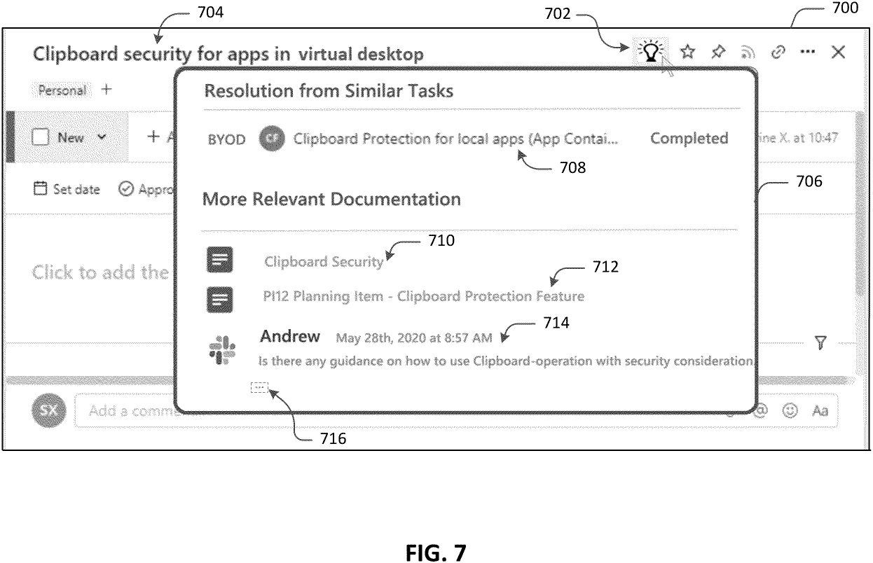

FIG. 7 shows an example of a user interface (UI) that may be used to present information relevant to an assigned task to a user who is assigned the task, in accordance with an embodiment of the present disclosure. An illustrative UI 700 may be implemented within a resource access application, such as resource access application 504 of FIG. 5. UI 700 may operate to provide a user notification of a task assigned to the user within the organization’s project management application (e.g., project management service 510 of FIG. 5). As shown in FIG. 7, UI 700 can include an idea icon 702 which can be activated (e.g., clicked, tapped, or selected) to obtain information relevant to the assigned task.

In the example of FIG. 7, UI 700 may be presented to a user to inform the user of an assigned task. The assigned task may be a new task or an existing task in project management service 510. For example, as indicated by reference numeral 704, the user may be assigned a task titled “Clipboard security for apps in virtual desktop.” To obtain a better understanding of the assigned task, the user may activate idea icon 702 to obtain information that is relevant to the assigned task.

In response to the user activating idea icon 702, UI 700 can check to determine whether information relevant to the assigned task is included in or with the task assignment. For example, a user who created the task may have included information regarding materials that are relevant to the assigned task in the task description. If information regarding materials that are relevant to the assigned task is included in the task assignment, UI 700 can display the information relevant to the assigned task in a popup window 706. Otherwise, if information regarding materials that are relevant to the assigned task is not included in the task assignment, UI 700 can cause a request to be sent to project management service 510 to obtain information relevant to the assigned task. In the example of FIG. 7, it is assumed that the task assignment did not include information regarding materials that are relevant to the assigned task.

The request sent to project management service 510 may include the user’s identifier (e.g., a unique user identifier of the user) and a summary of the assigned task (e.g., a task title, a brief description of the assigned task, etc.) which project management service 510 can use to determine whether there are materials that are relevant to the assigned task. Project management service 510 can identify materials that are relevant to the assigned task using task recommendation module 518 (e.g., to identify existing tasks that are similar to the assigned task), document recommendation module 520 (e.g., to identify existing documents that are relevant to the assigned task), and message recommendation module 522 (e.g., to identify existing messages that are relevant to the assigned task). In some embodiments, project management service 510 can determine whether the user is permitted to access the identified materials (e.g., the identified existing tasks, existing documents, and existing messages) using security module 524. Project management service 510 can send information regarding the materials that are relevant to the assigned task and which the user is permitted to access to task agent 508.

In response to the information regarding the materials that are relevant to the assigned task being received, UI 700 can display the received information in popup window 706. As shown in popup window 706, an existing task titled “Clipboard Protection for local apps (App Conti...” in project “BYOD” and assigned to a user identified by the letters “CF” is identified as an existing task that is similar to the assigned task (see reference numeral 708). As also shown in popup window 706, two (2) TRELLO documents are identified as documents that are relevant to the assigned task (see reference numerals 710, 712), and a SLACK message is identified as a message that is relevant to the assigned task (see reference numeral 714). In this example, popup window 706 also includes an ellipsis icon 716 which indicates additional information relevant to the assigned task (e.g., additional information regarding materials relevant to the assigned task) is available. The user can activate ellipsis icon 716 to cause task agent 508 to display the additional information that is relevant to the assigned task in popup window 706. The user can then consider the information relevant the assigned task displayed in popup window 706 as references in performing the assigned task titled “Clipboard security for apps in virtual desktop.”

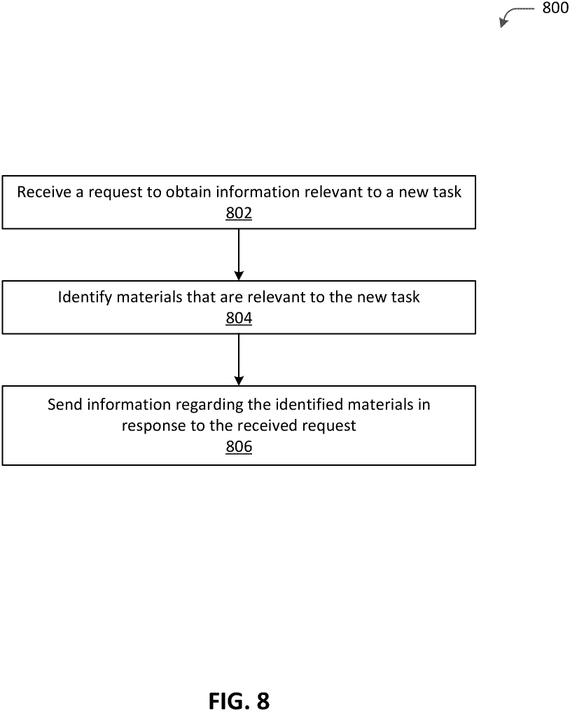

FIG. 8 is a flow diagram of an illustrative process 800 for presenting information relevant to a new task to a user who is creating the new task, in accordance with an embodiment of the present disclosure. Process 800 may be implemented, for example, within project management service 510 and executed in response to project management service 510 receiving a request for information relevant to a new task from task agent 508 (e.g., a user activating a “suggestion” button).

With reference to process 800, at 802, project management service 510 receives a request for information relevant to a new task. The request can be sent by a task agent 508 on a client device 502 being used by a user. The request can correspond to the user clicking a “suggestion” button provided in a UI to obtain information relevant to a new task that the user is creating. The request can include an identifier of the user making the request and a summary of the new task.

At 804, in response to the request being received, project management service 510 identifies materials that are relevant to the new task. In some embodiments, project management service 510 can use project recommendation module 516 to identify a project/space that is relevant to the new task. In some embodiments, project management service 510 can use task recommendation module 518 to identify existing tasks that are similar to the new task. In some embodiments, project management service 510 can use document recommendation module 520 to identify documents that are relevant to the new task. In some embodiments, project management service 510 can use message recommendation module 522 to identify messages that are relevant to the new task.

At 806, project management service 510 sends information regarding the identified materials that are relevant to the new task in response to the received request. The response can be sent to task agent 508 that sent the request for information relevant to the new task. Task agent 508 can then display (e.g., present) the received information relevant to the new task on a display of client device 502. In some embodiments, project management service 510 can check a security policy defined for the user to determine that the user is permitted to access the identified materials prior to sending the response to task agent 508.

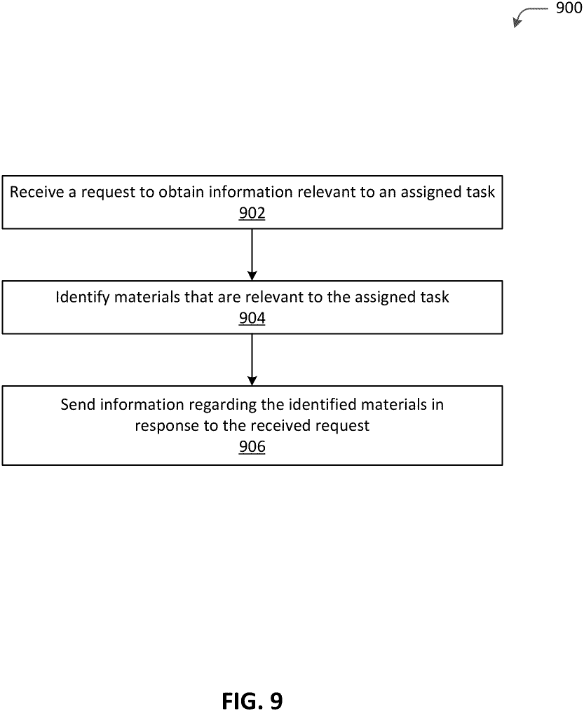

FIG. 9 is a flow diagram of an illustrative process 900 for presenting information relevant to an assigned task to a user who is assigned the task, in accordance with an embodiment of the present disclosure. Process 900 may be implemented, for example, within project management service 510 and executed in response to project management service 510 receiving a request for information relevant to an assigned task from task agent 508 (e.g., a user activating an idea icon).

With reference to process 900, at 902, project management service 510 receives a request for information relevant to an assigned task. The request can be sent by a task agent 508 on a client device 502 being used by a user. The request can correspond to the user clicking an idea icon provided in a UI to obtain information relevant to a task that is assigned to the user. The request can include an identifier of the user making the request and a summary of the assigned task.

At 904, in response to the request being received, project management service 510 identifies materials that are relevant to the assigned task. In some embodiments, project management service 510 can use task recommendation module 518 to identify existing tasks that are similar to the assigned task. In some embodiments, project management service 510 can use document recommendation module 520 to identify documents that are relevant to the assigned task. In some embodiments, project management service 510 can use message recommendation module 522 to identify messages that are relevant to the assigned task.

At 906, project management service 510 sends information regarding the identified materials that are relevant to the assigned task in response to the received request. The response can be sent to task agent 508 that sent the request for information relevant to the assigned task. Task agent 508 can then display (e.g., present) the received information relevant to the assigned task on a display of client device 502. In some embodiments, project management service 510 can check a security policy defined for the user to determine that the user is permitted to access the identified materials prior to sending the response to task agent 508.

### Further Example Embodiments

The following examples pertain to further embodiments, from which numerous permutations and configurations will be apparent.

Example 1 includes a method including: receiving, by a computing device, a summary of a task; determining, by the computing device using one or more machine learning models, information relevant to the task based on the summary of the task; and, responsive to the determination, outputting, by the computing device, the information relevant to the task for use in assigning the task.

Example 2 includes the subject matter of Example 1, wherein the information relevant to the task includes information identifying a project within which to assign the task.

Example 3 includes the subject matter of any of Examples 1 and 2, wherein the information relevant to the task includes information regarding a previously generated task having one or more attributes in common with the task.

Example 4 includes the subject matter of any of Examples 1 through 3, wherein the information relevant to the task includes information identifying a user appropriate to assign the task to.

Example 5 includes the subject matter of any of Examples 1 through 4, wherein the information relevant to the task includes information identifying a document that is relevant to the task.

Example 6 includes the subject matter of any of Examples 1 through 5, wherein the information relevant to the task includes information identifying a communication that is relevant to the task.

Example 7 includes the subject matter of any of Examples 1 through 6, further including: receiving, by the computing device, an assignment of another task to an assignee; and, responsive to a determination that additional information relevant to the assigned another task is not provided with the assignment of the another task: determining, by the computing device, one or more items of information relevant to the another task based on the assignment of the another task; and presenting, by the computing device, the information relevant to the another task to the assignee.

Example 8 includes a system including a processor and a non-volatile memory storing computer program code that when executed on the processor causes the processor to execute a process operable to: receive a summary of a task; determine, using one or more machine learning models, information relevant to the task based on the summary of the task; and, responsive to the determination, output the information relevant to the task for use in assigning the task.

Example 9 includes the subject matter of Example 8, wherein the information relevant to the task includes information identifying a project within which to assign the task.

Example 10 includes the subject matter of any of Examples 8 and 9, wherein the information relevant to the task includes information regarding a previously generated task having one or more attributes in common with the task.

Example 11 includes the subject matter of any of Examples 8 through 10, wherein the information relevant to the task includes information identifying a user appropriate to assign the task to.

Example 12 includes the subject matter of any of Examples 8 through 11, wherein the information relevant to the task includes information identifying a document that is relevant to the task.

Example 13 includes the subject matter of any of Examples 8 through 12, wherein the information relevant to the task includes information identifying a communication that is relevant to the task.

Example 14 includes the subject matter of any of Examples 8 through 13, wherein the process is further operable to: receive an assignment of another task to an assignee; and, responsive to a determination that additional information relevant to the assigned another task is not provided with the assignment of the another task: determine one or more items of information relevant to the another task based on the assignment of the another task; and present the information relevant to the another task to the assignee.

Example 15 includes a method including: receiving, by a computing device, an assignment of a task to an assignee; and, responsive to a determination that additional information relevant to the assigned task is not provided with the assignment of the task: determining, by the computing device, one or more items of information relevant to the task based on the assignment of the task; and presenting, by the computing device, the information relevant to the task to the assignee.

Example 16 includes the subject matter of Example 15, wherein the information relevant to the task includes information regarding a previously generated task having one or more attributes in common with the task.

Example 17 includes the subject matter of any of Examples 15 and 16, wherein the information relevant to the task includes information identifying a user appropriate to assign the task to.

Example 18 includes the subject matter of any of Examples 15 through 17, wherein the information relevant to the task includes information identifying a document that is relevant to the task.

Example 19 includes the subject matter of any of Examples 15 through 18, wherein the information relevant to the task includes information identifying a communication that is relevant to the task.

Example 20 includes the subject matter of any of Examples 15 through 19, wherein the one or more items of information relevant to the task are determined using one or more machine learning models.

Example 21 includes a system including a processor and a non-volatile memory storing computer program code that when executed on the processor causes the processor to execute a process operable to: an assignment of a task to an assignee; and, responsive to a determination that additional information relevant to the assigned task is not provided with the assignment of the task: determine one or more items of information relevant to the task based on the assignment of the task; and present the information relevant to the task to the assignee.

Example 22 includes the subject matter of Example 21, wherein the information relevant to the task includes information regarding a previously generated task having one or more attributes in common with the task.

Example 23 includes the subject matter of any of Examples 21 and 22, wherein the information relevant to the task includes information identifying a user appropriate to assign the task to.

Example 24 includes the subject matter of any of Examples 21 through 23, wherein the information relevant to the task includes information identifying a document that is relevant to the task.

Example 25 includes the subject matter of any of Examples 21 through 24, wherein the information relevant to the task includes information identifying a communication that is relevant to the task.

Example 26 includes the subject matter of any of Examples 21 through 25, wherein the one or more items of information relevant to the task are determined using one or more machine learning models.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
receiving, by a computing device, a summary of a task;
determining, by the computing device using one or more machine learning models, information relevant to the task based on the summary of the task; and
responsive to the determination, outputting, by the computing device, the information relevant to the task for use in assigning the task.

2. The method of claim 1, wherein the information relevant to the task includes information identifying a project within which to assign the task.

3. The method of claim 1, wherein the information relevant to the task includes information regarding a previously generated task having one or more attributes in common with the task.

4. The method of claim 1, wherein the information relevant to the task includes information identifying a user appropriate to assign the task to.

5. The method of claim 1, wherein the information relevant to the task includes information identifying a document that is relevant to the task.

6. The method of claim 1, wherein the information relevant to the task includes information identifying a communication that is relevant to the task.

7. The method of claim 1, further comprising:
receiving, by the computing device, an assignment of another task to an assignee; and
responsive to a determination that additional information relevant to the assigned another task is not provided with the assignment of the another task:
determining, by the computing device, one or more items of information relevant to the another task based on the assignment of the another task; and
presenting, by the computing device, the information relevant to the another task to the assignee.

8. A system comprising:
a processor; and
a non-volatile memory storing computer program code that when executed on the processor causes the processor to execute a process operable to:
receive a summary of a task;
determine, using one or more machine learning models, information relevant to the task based on the summary of the task; and
responsive to the determination, output the information relevant to the task for use in assigning the task.

9. The system of claim 8, wherein the information relevant to the task includes information identifying a project within which to assign the task.

10. The system of claim 8, wherein the information relevant to the task includes information regarding a previously generated task having one or more attributes in common with the task.

11. The system of claim 8, wherein the information relevant to the task includes information identifying a user appropriate to assign the task to.

12. The system of claim 8, wherein the information relevant to the task includes information identifying a document that is relevant to the task.

13. The system of claim 8, wherein the information relevant to the task includes information identifying a communication that is relevant to the task.

14. The system of claim 8, wherein the process is further operable to:
receive an assignment of another task to an assignee; and
responsive to a determination that additional information relevant to the assigned another task is not provided with the assignment of the another task:
determine one or more items of information relevant to the another task based on the assignment of the another task; and
present the information relevant to the another task to the assignee.

15. A method comprising:
receiving, by a computing device, an assignment of a task to an assignee; and responsive to a determination that additional information relevant to the assigned task is not provided with the assignment of the task:
determining, by the computing device, one or more items of information relevant to the task based on the assignment of the task; and
presenting, by the computing device, the information relevant to the task to the assignee.

16. The method of claim 15, wherein the information relevant to the task includes information regarding a previously generated task having one or more attributes in common with the task.

17. The method of claim 15, wherein the information relevant to the task includes information identifying a user appropriate to assign the task to.

18. The method of claim 15, wherein the information relevant to the task includes information identifying a document that is relevant to the task.

19. The method of claim 15, wherein the information relevant to the task includes information identifying a communication that is relevant to the task.

20. The method of claim 15, wherein the one or more items of information relevant to the task are determined using one or more machine learning models.
